(19) United States
(12) Patent Application Publication
(10) Pub. No.: US 2003/0156639 A1
(43) Pub. Date: Aug. 21, 2003

(54) Frame rate control system and method

(76) Inventor: Jui Liang, Laguna Niguel, CA (US)

Correspondence Address: Pillsbury Winthrop LLP, Intellectual Property Group, 50 Fremont Street, P.O. Box 7880, San Francisco, CA, 94105, US

(21) Appl. No.: 10/087,450

(22) Filed: Feb. 28, 2002

Related U.S. Application Data
(60) Provisional application No. 60/358,432, filed on Feb. 19, 2002.

(51) Int. Cl. H04N 7/12

(52) U.S. Cl. 375/240.01; 348/419.1

(57) ABSTRACT

A system and method of controlling the frame rate of signals for a video display device may employ a first-in/first-out (FIFO) frame rate control strategy for analog image source signals in conjunction with LCD panels. The disclosed system and method may dynamically adjust the frequency at which data are read out of a FIFO buffer, accounting for any frame rate differences between the source image data signal and the destination display device. Additionally, resolution of the output image may be adjusted to conform with the capabilities of the display apparatus.

### CROSS-REFERENCE TO RELATED APPLICATIONS

This application claims the benefit of co-pending U.S. provisional application Serial No. 60/______, entitled “GRAPHICAL FRAME RATE CONTROLLER,” filed Feb. 19, 2002.

### BACKGROUND

1. Field of the Invention

Aspects of the present invention relate generally to conversion of data signals for video display devices, and more particularly to a system and method of controlling the frame rate of signals for a video display device.

2. Description of the Related Art

Conventional personal computers (PCs) and other computerized systems are typically coupled to one or more monitors or other output devices which are configured to display text and graphics. In operation, a PC or other computer terminal generally outputs analog signals to a monitor or display apparatus; these analog signals typically comprise several components such as red (R), green (G), and blue (B) constituent video signals, as well as vertical and horizontal video synchronization signals (Vsync and Hsync, respectively). In accordance with current technology, the resolution of the display image and the frame rate or refresh rate (i.e. the frequency at which the display data are refreshed) are established by the analog signals, which are converted by appropriate circuitry to digital signals upon reception at the display device.

Consequently, various characteristics of the display resolution and the frame rate may be predetermined or selectively controlled by the PC or other source of the analog signals. Typical hardware and system configurations attempt to create analog signals such that the selected image characteristics correspond to the capabilities of the display panel or monitor.

Traditional cathode ray tube (CRT) technology implements all of the constituent (R, G, and B) video signals, as well as both the Vsync and Hsync signals, to produce an image for display; CRT displays support multiple frame rates and are readily configurable to display a broad range of image resolutions. In contrast, liquid crystal display (LCD) panels generally only support a single image resolution and are limited to a narrow range of refresh rates relative to the range supported by typical CRT monitors.

Accordingly, hardware implementations providing traditional analog video signal output to LCD panels are limited by conventional technology in at least the following respects: the frame rate of the source image specified by the source analog signal may differ from the frame rates supported by the LCD panel; the source image resolution may differ from the resolution supported by the LCD panel; or both.

Minimizing or eliminating discrepancies between the source analog signal image characteristics and the capabilities of the display apparatus require costly hardware modifications or involve manipulation of the nature of the image or the frame rate, or both. For example, incompatible hardware combinations may require that image resolution be scaled, in which case the aspect ratio of the source image may be lost during resolution conversion; additionally or alternatively, a frame buffer or other hardware elements may be required to synchronize display output with the frame rate of the source analog signal. Current technology fails adequately to address these complications.

### BRIEF DESCRIPTION OF THE DRAWINGS

FIG. 1 is a simplified block diagram illustrating one embodiment of a frame rate control system.

FIG. 2 is a simplified flow diagram illustrating the general operation of one embodiment of a frame rate control method.

### DETAILED DESCRIPTION

Embodiments of the present invention overcome various shortcomings of conventional technology, providing a system and method of controlling the frame rate of video signals transmitted to a video display such as may be employed in computerized systems. In accordance with one aspect of the present invention, for example, a first-in/first-out (FIFO) frame rate control strategy may minimize complications in systems utilizing analog image source signals in conjunction with LCD panels.

A frame rate control system and method may dynamically adjust the frequency at which data are read out of a frame buffer, accounting for any frame rate differences between the source image data signal and the destination display device. Additionally, resolution of the output image may be adjusted to conform with the capabilities of the display apparatus.

The foregoing and other aspects of various embodiments of the present invention will be apparent through examination of the following detailed description thereof in conjunction with the accompanying drawings.

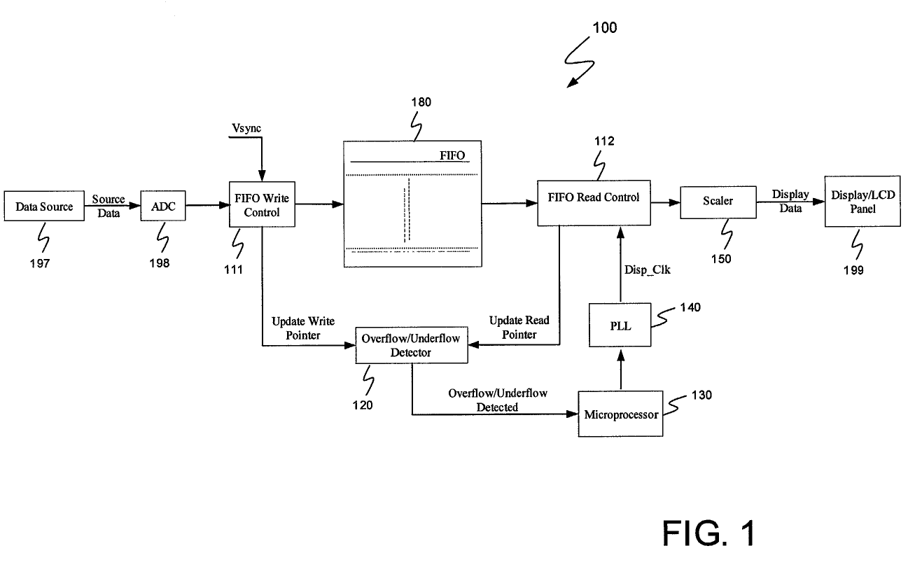

Turning now to the drawings, FIG. 1 is a simplified block diagram illustrating one embodiment of a frame rate control system. The exemplary FIG. 1 frame rate control system 100 generally comprises: a FIFO buffer 180; write control (111) and read control (112) components, both of which are coupled to an overflow/underflow detector 120; a microprocessor 130; frequency control component such as a phase locked loop (PLL) 140; and a scaler component 150. As illustrated in FIG. 1, system 100 may be coupled to a data source 197, from which data signals may be converted through an analog to digital converter (ADC) 198, and to a display apparatus such as an LCD panel 199.

As is generally known in the art, data source 197 may be a personal computer (PC) or workstation, a laptop or notebook computer, a personal digital assistant (PDA), a wireless or wire-line telephone, or any other computerized or electronic device configured to provide graphical image or text data for display. Analog source image data transmitted from data source 197 may be converted to digital signals by ADC 198; various methods of converting data are generally known in the art, as are many implementations of ADC 198. The present disclosure is not intended to be limited by the specific nature or constitution of either data source 197 or ADC 198.

FIFO buffer 180 may be any suitable data storage medium for storing or buffering data; data buffers and storage media comprising addressable memory locations, for example, are generally known in the art. In some embodiments, buffer 180 may be selectively expandable or scalable to a desired capacity; additionally or alternatively, buffer 180 may be implemented as a removable card or memory chip. In this latter embodiment, for example, an inadequate or inappropriate buffer 180 may be removed from system 100 and replaced with another buffer having a desired capacity or performance characteristics.

Converted source image data may be transmitted from ADC 198 to FIFO write control component 111, for example, through an appropriate source signal interface (not shown). In operation, write control component 111 may continuously (i.e. without interruption) write source data into FIFO buffer 180. In some embodiments, write control component 111 may receive a vertical synchronization (Vsync) signal. The Vsync signal may accurately reflect the characteristics or nature of the Vsync component of the original analog signal; alternatively, the Vsync component of the original analog source signal may be modified, amplified, or otherwise processed prior to or during transmission to write control component 111. In the FIG. 1 embodiment, the Vsync signal input may enable write control component 111 to determine the beginning of an image frame, which may facilitate write operations.

FIFO read control component 112 may continuously read source image data from buffer 180; read control component 112 may be selectively operable, responsive to a display clock (disp_clk) signal, to read data at a desired clock rate or frequency. It will be appreciated by those of skill in the art that the disp_clk signal may be generated by any suitable frequency controller or frequency adjusting circuit element such as PLL 140. In operation, disp_clk may generally be manipulated such that read control component 112 is operable to read data from buffer 180 at a frequency within the range of refresh rates supported by the destination LCD panel 199 or other video output apparatus.

As indicated in FIG. 1, during data write and read operations, a write pointer and a read pointer, respectively, may be updated by each respective control component 111, 112. By comparing the pointers, overflow/underflow detector 120 may ascertain whether a buffer overflow or a buffer underflow has occurred. In that regard, detector 120 may be configured to output an appropriate signal responsive to an overflow condition and to output a different signal responsive to an underflow condition. If either an overflow or an underflow is detected, output from overflow/underflow detector 120 may be transmitted to microprocessor 130.

Responsive to data signals received from detector 120 and other information, microprocessor 130 may be selectively operative to program or otherwise to reconfigure PLL 140; accordingly, a new disp_clk signal may be generated to rectify or to mitigate any detected overflow or underflow condition. It will be appreciated that microprocessor 130 may be embodied in any suitable microcontroller or microcomputer known in the art.

In the foregoing manner, a system and method of frame rate control may dynamically adjust the frequency at which data are read out of FIFO buffer 180, accounting for any frame rate differences between the source image data signal and the destination display device, and correcting a buffer overflow condition or a buffer underflow condition. Continuous operation of write and read control components 111, 112 may ensure that data are not lost, i.e. every frame of data is written to and read from FIFO buffer 180.

For example, if the source image (“Source Data” at the left side of FIG. 1) is coming in faster than the display information (“Display Data” at the right side of FIG. 1) is being sent to LCD panel 199 (i.e. the source image data are written to buffer 180 at a higher frequency than the data are read out of buffer 180), detector 120 may identify a discrepancy in the write and read pointers representative of an overflow condition; the frequency of the disp_clk signal may be increased appropriately, increasing the frequency at which data are read out of buffer 180. Alternatively, if the source image is coming in slower than the display information is being sent to LCD panel 199 (i.e. the source image data are written to buffer 180 at a lower frequency than the data are read out of buffer 180), detector 120 may identify a discrepancy in the write and read pointers representative of an underflow condition. In this case, the frequency of the disp_clk signal may be decreased appropriately, decreasing the frequency at which data are read out of buffer 180.

In the exemplary FIG. 1 embodiment, system 100 includes a scaler 150 configured to interpolate and to extrapolate data transmitted from read control component 112. Scaler 150 may interpolate or extrapolate data in both the horizontal and the vertical directions; in accordance with this embodiment, scaler 150 may either add or delete data to create a display data signal based upon one or more predetermined or dynamically requested scaling algorithms. In that regard, scaler 150 may apply scaling algorithms generally known in the art or developed and operative in accordance with known principles. The foregoing strategy may enable a system and method of frame rate control dynamically to adjust or to modify the resolution of the output image to conform with the capabilities or requirements of the display apparatus.

For example, during scaling up (i.e. increasing image resolution) procedures, scaler 150 may add data to the source image data for display at destination devices such as LCD 199; in this instance, the disp_clk signal frequency may be increased to accommodate processing time required for augmenting the signal with additional data. Alternatively, for scaling down, scaler 150 may delete data from the source image such that the image transmitted to the destination display is of lower resolution than the source; in this instance, the frequency of the disp_clk signal may be reduced.

It will be appreciated that the illustrated elements of system 100 may be implemented as hardware components or software modules, for example, and may be embodied in one or more devices; the elements' respective functionality set forth above may be facilitated by hardware or firmware instruction sets, for instance, or by software programming code. In that regard, computer executable software instructions and other data may be encoded on a computer readable medium (not shown) and allow hardware elements such as illustrated in FIG. 1 to cooperate as set forth in detail herein. In some implementations, some or all of the components of system 100 may be incorporated into a single hardware card or board which may be installed at or coupled to data source 197; alternatively, some or all of the functionality of system 100 may be incorporated in the destination video display apparatus such as LCD 199.

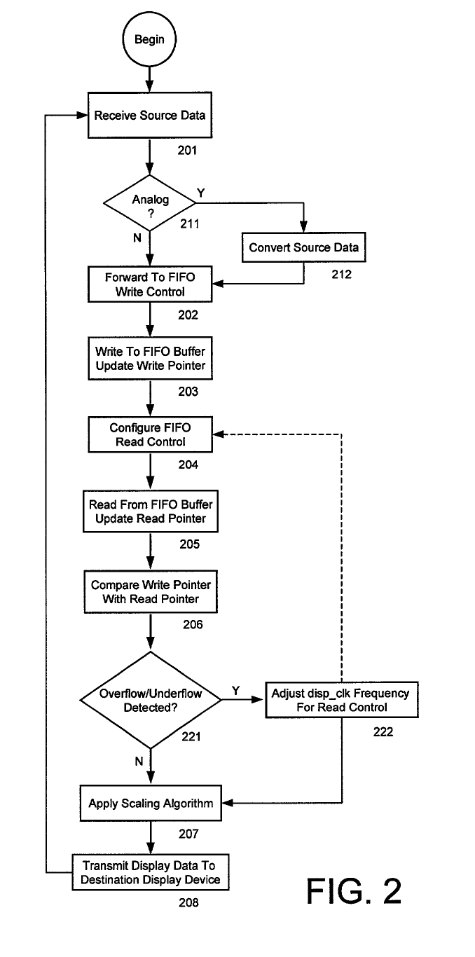

FIG. 2 is a simplified flow diagram illustrating the general operation of one embodiment of a frame rate control method. As set forth in detail above with reference to FIG. 1 and as indicated at block 201 in FIG. 2, a frame rate control system may receive video frame source data. As noted above, source data may be in analog form even in configurations where the destination display device requires digital signals; consequently, analog to digital conversion of source data may be required in some embodiments. Alternatively, appropriate hardware and software components providing aspects of frame rate control functionality may be integrated with the source device; in such an alternative embodiment, a frame rate control system may be responsible, at least in part, for generating the source data.

In the FIG. 2 embodiment, appropriate hardware and software elements may enable a frame rate control system to ascertain whether a source data signal arriving at a source signal interface is analog in form, as indicated at decision block 211. If the source data are provided in an analog signal, appropriate ADC circuitry may convert the source data as required (block 212); if the data are provided in a digital signal, however, the source digital signal may be transmitted without conversion.

Digital video frame source data may be forwarded to a FIFO write control component as indicated at block 202. As set forth above, a write control component (such as represented by reference numeral 111 in FIG. 1) may provide useful reference information in a dynamically adjustable frame rate control system. In that regard, a write control component may write data to a suitable buffer or other data structure, and may additionally update a write pointer as indicated at block 203; in some embodiments, the write pointer may be updated at each write operation. The write control component may execute the operations indicated at block 203 at a predetermined or selected image source signal frequency, which may be determined by the source device.

Read control functionality may be facilitated by read control component 112 in FIG. 1; in the FIG. 2 embodiment, a read control component may be initialized or otherwise configured (block 204) to operate at a particular read, or display, frequency. Data may be read from the buffer at a predetermined or a selected frequency, and a read pointer may be updated as indicated at block 205; as with the write pointer, the read pointer may be updated at each read operation. As set forth in detail above, the read frequency may be dynamically adjustable responsive to a comparison of the write and read pointers.

It will be appreciated that the write control (111) and read control (112) components illustrated in FIG. 1, as well as their respective functionality represented at blocks 203 and 205, may be integrated into a single hardware component or module; such a multifunction hardware element may be embodied in a removable card or chip, for example, facilitating repair or replacement of write/read control as appropriate for overall system requirements. In the FIG. 1 embodiment where write and read control are separately implemented in independent hardware, one or both of control components 111, 112 may be embodied in removable or replaceable hardware chips or boards such that write and read functionality may be independently upgraded with new or improved hardware.

A frame rate control system may compare the updated write pointer with the updated read pointer as indicated at block 206. Comparison of write and read pointers, as well as respective update information, may enable an accurate assessment of the flow of data into and out of the buffer. Those of skill in the art will appreciate that relevant information related to each pointer may be updated with each respective write and read operation. Such information may include the volume or size of each data frame (measured, for example, in terms of bytes or the number of allocated memory addresses), buffer addresses occupied by each frame or portion thereof, time stamp information associated with each write and read, and the like. The specific amount and nature of information related to each write and read pointer may be a function of overall system requirements, and may be modified to suit particular applications.

In particular, a frame rate control system and method may measure the rate at which data frames are written to the buffer (i.e. image source signal frequency) relative to the rate at which data frames are read from the buffer (i.e. read frequency). Based upon a comparison of information related to write pointers and read pointers, for example, a buffer overflow or underflow condition may be detected as indicated at decision block 221.

Responsive to a determination of overflow or underflow, a frame rate control system may appropriately adjust the disp_clk frequency (block 222). As indicated by the dashed line in FIG. 2, the disp_clk frequency may facilitate configuration of the read control component; as set forth in detail above, such configuration may employ a frequency control element (such as a PLL, for example) under control of a microprocessor. Accordingly, the read frequency may be dynamically adjusted as a function of buffer overflow or underflow, and the buffer overflow or underflow may be corrected.

A display signal output may be transmitted to the destination display device at block 208 following any scaling, which may be optional, for example, or necessitated by resolution requirements of the display device. In that regard, a frame rate control system may selectively apply one or more suitable scaling algorithms (block 207) operative to adjust resolution of the display image to a resolution supported by the display, i.e. the system may modify the source data to conform with the capabilities of the display apparatus. Where the scaling algorithm requires adding data to the source data, the display frequency may be increased accordingly; conversely, where the scaling algorithm requires deleting data from the source data, the display frequency may be decreased. As set forth in detail above, ordinary operation of the write and read control components may account for scaling or resolution modification process overhead, adjusting the frequency with which data frames are read from the buffer as a function of a comparison of the appropriate write and read pointers.

It will be appreciated that the FIG. 2 embodiment is exemplary, and that the specific order of the illustrated operations is not intended to be construed in any limiting sense, i.e. the representation of the blocks in FIG. 2 is not intended to imply a particular order of operations to the exclusion of other possibilities. For example, configuration of the read control component represented at block 204 may occur prior to any of blocks 211, 212, 202, or 203. As another example, the comparison at block 206 may occur substantially simultaneously with the reads and updates executed at block 205.

Aspects of the present invention have been illustrated and described in detail with reference to particular embodiments by way of example only, and not by way of limitation. Those of skill in the art will appreciate that various modifications to the disclosed embodiments are within the scope and contemplation of the present disclosure. Therefore, it is intended that the invention be considered as limited only by the scope of the appended claims.

What is claimed is:

1. A method of controlling a frame rate; the method comprising:
writing source data to a buffer and updating a write pointer;
reading the source data from the buffer and updating a read pointer;
comparing the write pointer and the read pointer; and
adjusting a frequency of the reading responsive to the comparing.

2. The method of claim 1 further comprising:
receiving an analog image source signal from an image source; and
generating the source data by converting the image source signal to digital form.

3. The method of claim 1 wherein the writing comprises writing the source data to the buffer at an image source frequency.

4. The method of claim 3 wherein the reading comprises reading the source data from the buffer at a display frequency.

5. The method of claim 4 wherein the adjusting comprises configuring a read control component to read the source data from the buffer at the image source frequency.

6. The method of claim 1 wherein the comparing comprises detecting a buffer overflow condition.

7. The method of claim 6 wherein the adjusting comprises selecting a frequency for the reading to correct the buffer overflow condition.

8. The method of claim 1 wherein the comparing comprises detecting a buffer underflow condition.

9. The method of claim 8 wherein the adjusting comprises selecting a frequency for the reading to correct the buffer underflow condition.

10. The method of claim 1 further comprising modifying the source data in accordance with capabilities of a display device.

11. The method of claim 10 wherein the modifying comprises applying a scaling algorithm.

12. A frame rate control system comprising:
a buffer;
a write control component configured to write data frames to the buffer at an image source signal frequency; and
a read control component selectively operative to read the data frames from the buffer at a selected one of a plurality of display frequencies.

13. The system of claim 12 further comprising:
a scaler operative to modify the data frames in accordance with capabilities of a display device.

14. The system of claim 12 wherein the selected one of the plurality of display frequencies is equal to the source signal frequency.

15. The system of claim 12 further comprising:
a detector operative to receive information related to a write pointer from the write control component and to receive information related to a read pointer from the read control component; wherein the detector is further operative to detect a buffer overflow condition or a buffer underflow condition based upon a comparison of the information related to a write pointer and the information related to a read pointer.

16. The system of claim 15 wherein the detector is further operative to output a first signal responsive to the buffer overflow condition and to output a second signal responsive to the buffer underflow condition.

17. The system of claim 16 wherein the selected one of the plurality of display frequencies is selected in accordance with the first signal or the second signal.

18. The system of claim 12 further comprising a frequency controller configuring the read control component to operate at the selected one of the plurality of display frequencies.

19. The system of claim 18 wherein the frequency controller comprises a phase locked loop.

20. The system of claim 18 wherein the frequency controller is responsive to both a buffer overflow condition and a buffer underflow condition.

21. A method of controlling a frame rate of a display signal for a destination video display device; the method comprising:
receiving an image source signal comprising source data;
writing the source data to a buffer at a source frequency and updating a write pointer;
reading the source data from the buffer at a display frequency and updating a read pointer;
comparing information related to the write pointer and information related to the read pointer;
responsive to the comparing, detecting a buffer overflow condition or a buffer underflow condition;
modifying the source data in accordance with capabilities of the destination video display device; and
responsive to the detecting, adjusting the display frequency in accordance with the buffer overflow condition or the buffer underflow condition.

22. The method of claim 21 wherein the image source signal is analog, and further comprising generating the source data by converting the image source signal to digital form.

23. The method of claim 21 wherein the adjusting comprises configuring a read control component to read the source data from the buffer at a selected one of a plurality of display frequencies supported by the destination video display device.

24. The method of claim 23 wherein the adjusting comprises identifying one of the plurality of display frequencies to correct the buffer overflow condition or the buffer underflow condition.

25. The method of claim 21 wherein the modifying comprises applying a scaling algorithm.

26. The method of claim 25 wherein the adjusting is a function of the detecting and the modifying.

27. The method of claim 21 wherein the adjusting comprises utilizing a phase locked loop.

28. The method of claim 21 wherein the destination display device is a liquid crystal display.

29. The method of claim 24 wherein the adjusting comprises increasing the display frequency responsive to a buffer overflow condition and decreasing the display frequency responsive to a buffer underflow condition.

30. The method of claim 26 wherein the adjusting comprises increasing the display frequency when the modifying comprises adding data to the source data and decreasing the display frequency when the modifying comprises deleting data from the source data.

31. A frame rate control system providing display signals to a video display device; the system comprising:
a source signal interface receiving an image source signal;
a buffer;
a write control component operative to receive the image source signal and to write data frames from the image source signal to the buffer at an image source signal frequency; and
a read control component selectively operative to read the data frames from the buffer at a selected one of a plurality of display frequencies.

32. The system of claim 31 further comprising:
a scaler operative to modify the data frames in accordance with capabilities of the video display device.

33. The system of claim 31 wherein the selected one of a plurality of display frequencies is equal to the source signal frequency.

34. The system of claim 31 further comprising a frequency controller configuring the read control component to operate at the selected one of a plurality of read frequencies.

35. The system of claim 34 wherein the frequency controller comprises a phase locked loop.

36. The system of claim 34 further comprising:
a detector operative to receive information related to a write pointer from the write control component and to receive information related to a read pointer from the read control component; wherein the detector is further operative to detect a buffer overflow condition or a buffer underflow condition based upon a comparison of the information related to a write pointer and the information related to a read pointer.

37. The system of claim 36 wherein the frequency controller is responsive to signals received from the detector representative of the buffer overflow condition or the buffer underflow condition.

38. A computer readable medium encoded with data and computer executable instructions for controlling a frame rate of signals for a display device, the data and instructions causing an apparatus executing the instructions to:
write video frame source data to a buffer at a source frequency and update a write pointer;
read the source data from the buffer at a display frequency and update a read pointer;
compare the write pointer to the read pointer; and
responsive to a comparison of the write pointer and the read pointer, adjust the display frequency.

39. The computer readable medium of claim 38 further encoded with data and computer executable instructions and further causing an apparatus executing the instructions to:
receive an analog image source signal from a source;
convert the analog image source signal to a digital source signal; and
generate the video frame source data from the digital source signal.

40. The computer readable medium of claim 38 further encoded with data and computer executable instructions and further causing an apparatus executing the instructions to:
configure a read control component to operate at a selected one of a plurality of display frequencies supported by the display device.

41. The computer readable medium of claim 38 further encoded with data and computer executable instructions and further causing an apparatus executing the instructions to:
apply a scaling algorithm operative to modify the source data in accordance with capabilities of the display device.

42. The computer readable medium of claim 38 further encoded with data and computer executable instructions and further causing an apparatus executing the instructions to:
increase the display frequency responsive to a buffer overflow condition; and
decrease the display frequency responsive to a buffer underflow condition.

43. The computer readable medium of claim 41 further encoded with data and computer executable instructions and further causing an apparatus executing the instructions to:
increase the display frequency when the scaling algorithm adds data to the source data; and
decrease the display frequency when the scaling algorithm deletes data from the source data.
